(19) United States
(12) Patent Application Publication
(10) Pub. No.: US 2026/0359784 A1
(43) Pub. Date: Nov. 12, 2026

(54) UNSTRUCTURED REQUEST PROCESSING SYSTEMS AND METHODS

(71) Applicant: Rockwell Automation Technologies, Inc., Mayfield Heights, OH (US)

(72) Inventors: Joseph A. Bastulli, Concord Township, OH (US); Damaris Indari De Laat Plasmeijer, Vlaardingen (NL); Anupama D S, Bengaluru (IN); Meiling He, Shorewood, WI (US); Ronald Albert Lothar Leonardus Jansen, Roosendaal (NL); Jiri Malicek, Stara Boleslav (CZ); Francisco P. Maturana, Lyndhurst, OH (US); Ishit Patni, Pune (IN); Akshaya P S, Bangalore (IN); Daniel Radley, London (GB); Manoj Shetty K, Puttur (IN)

(21) Appl. No.: 19/202,935

(22) Filed: May 8, 2025

(51) Int. Cl. G06Q 10/0875; G06F 40/58

(52) U.S. Cl. CPC G06Q 10/0875; G06F 40/58

(57) ABSTRACT

Systems and methods of generating a bill of materials from unstructured data of a quotation request are described herein. For example, a system may receive, via a first application programming interface (API), incoming unstructured data. The system may generate a bill of materials (BOM) request with a quotation data structure at least in part by performing unstructured request processing on the unstructured data. The system may generate a bill of materials (BOM) dataset based on the quotation data structure. The system may send, via the first API, the BOM dataset.

### BACKGROUND

The present disclosure generally relates to industrial automation systems. More specifically, the present disclosure relates to techniques for processing unstructured quotation requests generated relative to industrial automation systems.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

A manufacturer of industrial automation system devices may respond to quotation requests with a bill of materials. Managing hardware quotation requests may pose a substantial challenge to process due to unstructured data included in respective quotation request, which may vary in data format and/or language from request to request, due to a possibility of omitted data, and due to volume of requests, where some manufacturers may receive thousands of quotation requests, such as more than 20,000 quotation requests in one year. Inefficient management of the quotation requests may introduce additional opportunity for misinterpretation or errors and consume relatively large amounts of computing as each translation or processing of a quotation request may duplicate computing operations associated with another quotation request processing or translation. For example, a computing device used in manual quotation request processing may consume a relatively high amount of computing resources, power, and/or network bandwidth through enabling access and searching of design documents, access and searching of specification sheets of components, or the like, while translating and processing the quotation request to build a bill of materials. Accordingly, it may be desirable to develop improved techniques for processing quotation requests in generating bill of materials.

### BRIEF DESCRIPTION

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In certain embodiments, a system may include processing circuitry and a memory accessible by the processing circuitry. The memory may store instructions that, when executed by the processing circuitry, cause the processing circuitry to perform operations. The operations may include receiving a quotation request including unstructured data. The operations may include generating a bill of materials (BOM) request. The BOM request may include first structured data. The operations may generate the BOM request at least in part by performing an unstructured request processing operation on the unstructured data that includes: extracting a first subset of the unstructured data with a first data format and a second subset of the unstructured data with a second data format; converting the second subset of the unstructured data from the second data format to the first data format; and generating the first structured data as including the first subset of the unstructured data in the first data format and the second subset of the unstructured data in the first data format.

In another embodiment, a non-transitory, tangible, computer-readable medium may include instructions that, when executed by processing circuitry, cause the processing circuitry to perform operations. The operations may include receiving a quotation request including unstructured data. The operations may include generating a bill of materials (BOM) request including a quotation data structure at least in part by: extracting a first subset of the unstructured data with a first data format and a second subset of the unstructured data with a second data format; converting the second subset of the unstructured data from the second data format to the first data format; and writing the first subset of the unstructured data in the first data format and the second subset of the unstructured data in the first data format into fields of the quotation data structure.

In another embodiment, a system may include processing circuitry and a memory accessible by the processing circuitry. The memory may store instructions that, when executed by the processing circuitry, cause the processing circuitry to perform operations. The operations may include receiving, via a first application programming interface (API), an incoming post request including unstructured data. The operations may include generating a bill of materials (BOM) request including a quotation data structure at least in part by performing unstructured request processing on the unstructured data; generating a bill of materials (BOM) dataset based on the quotation data structure; and sending, via the first API, an outgoing post request including the BOM dataset.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a schematic view of an operation technology (OT) environment communicatively couplable to an information technology (IT) environment, in accordance with an embodiment;

FIG. 2 is a block diagram of example components that could be used in the industrial automation system of FIG. 1, in accordance with an embodiment;

FIG. 3 is a perspective view of an industrial automation system as an example of the OT environment of FIG. 1, in accordance with an embodiment;

FIG. 4 is a block diagram of a process performed by a bill of materials processing system (BOM processing system) to generate a bill of materials dataset (BOM dataset) based on unstructured data of a quotation request, in accordance with an embodiment;

FIG. 5 is a flow chart of a process for generating the BOM dataset of FIG. 4, in accordance with an embodiment;

FIGS. 6A and 6B combine to form a block diagram of an example of the BOM processing system of FIG. 4, in accordance with an embodiment; and

FIGS. 7A and 7B are a diagrammatic representation of an example of a bill of materials request (BOM request) that includes structured data generated based on a quotation request, in accordance with an embodiment.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

As used herein, the term “computing system” refers to an electronic computing device such as, but not limited to, a single computer, virtual machine, virtual container, host, server, edge device, laptop, tablet, and/or mobile device, or to a plurality of electronic computing devices working together to perform the function described as being performed on or by the computing system. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads, and/or a set of computing instructions executed by a computing system. Example embodiments of an application include software modules, software objects, software instances and/or other types of executable code.

The present patent application is directed to techniques for generating projects of industrial automation systems by leveraging generative artificial intelligence (AI) operations or machine learning operations to analyze and extract features from a quotation request and from user documentation, such as control layouts, input/output (IO) sheets, bill of materials datasets (BOM datasets), piping and instrumentation diagrams (P&IDs), and the like, to generate BOM datasets. The generated BOM dataset(s) may be transmitted to a requesting device in satisfaction of the quotation request.

A computing device managed by a manufacturer of industrial automation system devices may receive a quotation request and generate a bill of materials based on data extracted from the quotation request. Extracting data from the quotation request may pose a substantial challenge when the data is unstructured data that may vary among formats, contents, and/or relative location within a dataset of the quotation request. For example, a first quotation request may include a product identifier (PID) at a first relative location within a first dataset, and a second quotation request may include a different PID at a second relative location within a second dataset different from the first relative location. Respective quotation requests may further differ from each other in that each quotation request may include a variety of data formats and/or languages, may exclude key data for bill of materials generation (e.g., PIDs or quantities, enterprise identities, delivery dates), or the like. There may be a lack of a systematic approach to organizing and consolidating BOM dataset-related information from various e-mail, communications, material masters, recordings, user documentation, or the like. Without a systematic approach, disorganization or operator errors may compound when catalog numbers or other identifiers are missing, making it difficult to match descriptions and ensure accuracy in BOM dataset generation. Resources spent processing, converting, or searching for key data may be further increased from duplicated operations arising from a volume of requests, where some manufacturers may receive thousands of quotation requests (e.g., 10,000, 20,000) each year. To address these challenges, it may be desirable to implement an automation system to manage unstructured, multimodal, or multilingual, or any combination of those three, data that may arise or be encountered in a quotation process or BOM dataset generation.

The disclosed techniques leverage AI operations or machine learning and natural language processing to generate, in response to a quotation request being received, a BOM dataset for that quotation request. To do so, the AI operations or machine learning operations and natural language processing may generate a BOM dataset based on parsing the quotation request and user documentation, which may include previously generated BOM datasets. For example, systems and methods of the present disclosure may utilize generative AI operations and natural language processing to identify a format of data included in the quotation request, a language of data of the quotation request, identification information of the quotation request, a product identifier identified by the quotation request, and other identifying or purchasing data. The system may process data of the quotation request to convert the data from a first data format into a second data format, from a first language into a second language, from a first mode into a second language, or any both, to perform further parsing of the data. In doing so, the system may change unstructured data from the quotation request into structured data, which may be used to build queries and generate BOM datasets. Accordingly, by leveraging generative AI operations and documents associated with the industrial automation system, the presently disclosed techniques may reduce processing time for quotations and bills of materials generated relative to industrial automation systems, reduce error in the bills of materials, and reduce computing resources spent duplicating processing of quotation requests to prepare to generate the bills of materials.

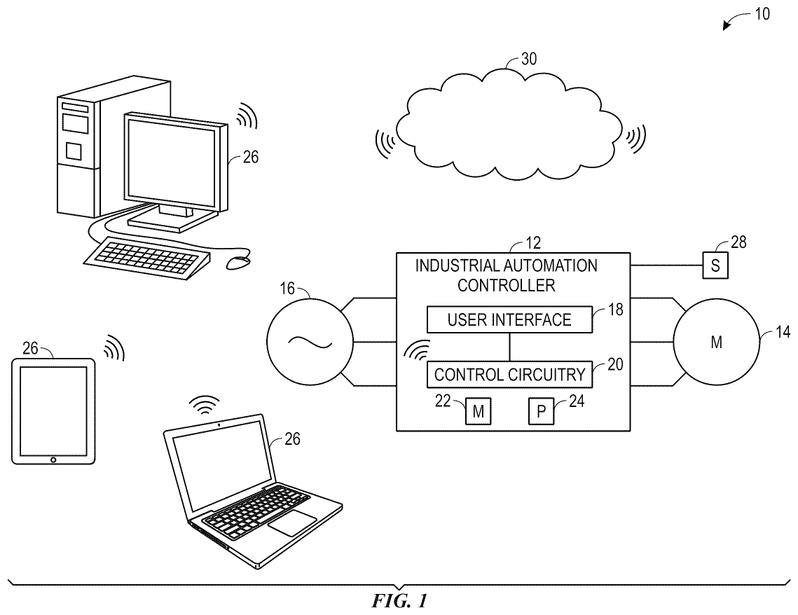

By way of introduction, FIG. 1 is a schematic view of an example operation technology (OT) environment 10 in which the embodiments described herein may be implemented. As shown, the OT environment 10 is an industrial automation system that includes a controller 12 and an actuator (e.g., a motor 14). The OT environment 10 may also include, or be coupled to, a power source 16. The power source 16 may include a generator, an external power grid, a battery, or some other source of power. The controller 12 may be a stand-alone control unit that controls multiple industrial automation components (e.g., a plurality of motors 14), a controller 12 that controls the operation of a single automation component (e.g., motor 14), or a subcomponent within a larger OT environment 10. In the instant embodiment, the controller 12 includes a user interface 18, such as a human machine interface (HMI), and a control system 20, which may include a memory 22 and a processor 24. The controller 12 may include a cabinet or some other enclosure for housing various components of the OT environment 10, such as a motor starter, a disconnect switch, etc.

The control system 20 may be programmed (e.g., via computer readable code or instructions stored on the memory 22, such as a non-transitory computer readable medium, and executable by the processor 24) to provide signals for controlling the motor 14. In certain embodiments, the control system 20 may be programmed according to a specific configuration desired for a particular application. For example, the control system 20 may be programmed to respond to external inputs, such as reference signals, alarms, command/status signals, etc. The external inputs may originate from one or more relays or other electronic devices. The programming of the control system 20 may be accomplished through software or firmware code that may be loaded onto the internal memory 22 of the control system 20 (e.g., via a locally or remotely located computing device 26) or programmed via the user interface 18 of the controller 12. The control system 20 may respond to a set of operating parameters. The settings of the various operating parameters may determine the operating characteristics of the controller 12. For example, various operating parameters may determine the speed or torque of the motor 14 or may determine how the controller 12 responds to the various external inputs. As such, the operating parameters may be used to map control variables within the controller 12 or to control other devices communicatively coupled to the controller 12. These variables may include, for example, speed presets, feedback types and values, computational gains and variables, algorithm adjustments, status and feedback variables, programmable logic controller (PLC) control programming, and the like.

In some embodiments, the controller 12 may be communicatively coupled to one or more sensors 28 for detecting operating temperatures, voltages, currents, pressures, flow rates, and other measurable variables associated with the OT environment 10. With sensor data fed back from the sensors 28, the control system 20 may keep detailed track of the various conditions under which the OT environment 10 may be operating. For example, sensor feedback data may include conditions such as actual motor speed, voltage, frequency, power quality, alarm conditions, etc. In some embodiments, the sensor feedback data may be communicated back to the computing device 26 for additional analysis.

The computing device 26 may be communicatively coupled to the controller 12 via a wired or wireless connection. The computing device 26 may receive inputs from a user defining an industrial automation project using a native application running on the computing device 26 or using a website accessible via a browser application, a software application, or the like. The user may define the industrial automation project by writing code, interacting with a visual programming interface, inputting or selecting values via a graphical user interface, or providing some other inputs. The user may use licensed software and/or subscription services to create, analyze, and otherwise develop the project. The computing device 26 may send a project to the controller 12 for execution. Execution of the industrial automation project causes the controller 12 to control components (e.g., motor 14) within the OT environment 10 through performance of one or more tasks and/or processes. In some applications, the controller 12 may be communicatively positioned in a private network and/or behind a firewall, such that the controller 12 does not have communication access outside a local network and is not in communication with any devices outside the firewall, other than the computing device 26. The controller 12 may collect the sensor feedback data during execution of the project, and the sensor feedback data may be provided back to the computing device 26 for analysis. Sensor feedback data may include, for example, one or more execution times, one or more alerts, one or more error messages, one or more alarm conditions, one or more temperatures, one or more pressures, one or more flow rates, one or more motor speeds, one or more voltages, one or more frequencies, and so forth. The project may be updated via the computing device 26 based on the analysis of the sensor feedback data.

The computing device 26 may be communicatively coupled to a remote/cloud server 30 or remote server via the internet, or some other network. In one embodiment, the remote/cloud server 30 may be operated by the manufacturer of the controller 12, a software provider, a seller of the controller 12, a service provider, operator of the controller 12, owner of the controller 12, etc. The remote/cloud server 30 may be used to help customers create and/or modify projects, to help troubleshoot any problems that may arise with the controller 12, develop policies, or to provide other services (e.g., project analysis, enabling, restricting capabilities of the controller 12, data analysis, controller firmware updates, etc.). The remote/cloud server 30 may be one or more servers operated by the manufacturer, software provider, seller, service provider, operator, or owner of the controller 12. The remote/cloud server 30 may be disposed at a facility owned and/or operated by the manufacturer, software provider, seller, service provider, operator, or owner of the controller 12. In other embodiments, the remote/cloud server 30 may be disposed in a datacenter in which the manufacturer, software provider, seller, service provider, operator, or owner of the controller 12 owns or rents server space. In further embodiments, the remote/cloud server 30 may include multiple servers operating in one or more data center to provide a cloud computing environment. The remote/cloud server 30 may couple to one or more computing systems associated with an information technology (IT) environment, such as the computing devices 26. For example, the OT environment 10 may send or receive data, such as the sensor feedback data, from the IT environment based on a wireless or wired communicative coupling between one or more of the computing devices 26 and the remote/cloud server 30.

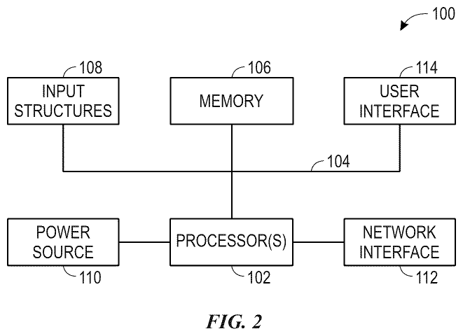

FIG. 2 illustrates a block diagram of example components of a computing device 100 that could be used as the computing device 26, the remote/cloud server 30, the controller 12, or some other device provided by the present disclosure. As used herein, the computing device 100 may be implemented as one or more computing systems including laptop, notebook, desktop, tablet, HMI, or workstation computers, as well as server type devices or portable, communication type devices, such as cellular telephones and/or other suitable computing devices.

As illustrated, the computing device 100 may include various hardware components, such as one or more processors 102, one or more busses 104, memory 106, input structures 108, a power source 110, a network interface 112, a user interface 114, and/or other computer components useful in performing the functions described herein.

The one or more processors 102 may include, in certain implementations, microprocessors configured to execute instructions stored in the memory 106 or other accessible locations. Alternatively, the one or more processors 102 may be implemented as application-specific integrated circuits (ASICs), field-programmable gate arrays (FPGAs), and/or other devices designed to perform functions discussed herein in a dedicated manner. As will be appreciated, multiple processors 102 or processing components may be used to perform functions discussed herein in a distributed or parallel manner.

The memory 106 may encompass any tangible, non-transitory medium for storing data or executable routines. Although shown for convenience as a single block in FIG. 2, the memory 106 may encompass various discrete media in the same or different physical locations. The one or more processors 102 may access data in the memory 106 via one or more busses 104.

The input structures 108 may allow a user to input data and/or commands to the computing device 100 and may include mice, touchpads, touchscreens, keyboards, controllers, and so forth. The power source 110 can be any suitable source for providing power to the various components of the computing device 100, including line and battery power. In the depicted example, the computing device 100 includes a network interface 112. Such a network interface 112 may allow communication with other devices on a network using one or more communication protocols. In the depicted example, the computing device 100 includes a user interface 114, such as a display that may display images or data provided by the one or more processors 102. The user interface 114 may include, for example, a monitor, a display, and so forth. As will be appreciated, in a real-world context a processor-based system, such as the computing device 100 of FIG. 2, may be employed to implement some or all of the present approach, such as performing the functions of the controller, the computing device 26, and/or the remote/cloud server 30 shown in FIG. 1, as well as other memory-containing devices.

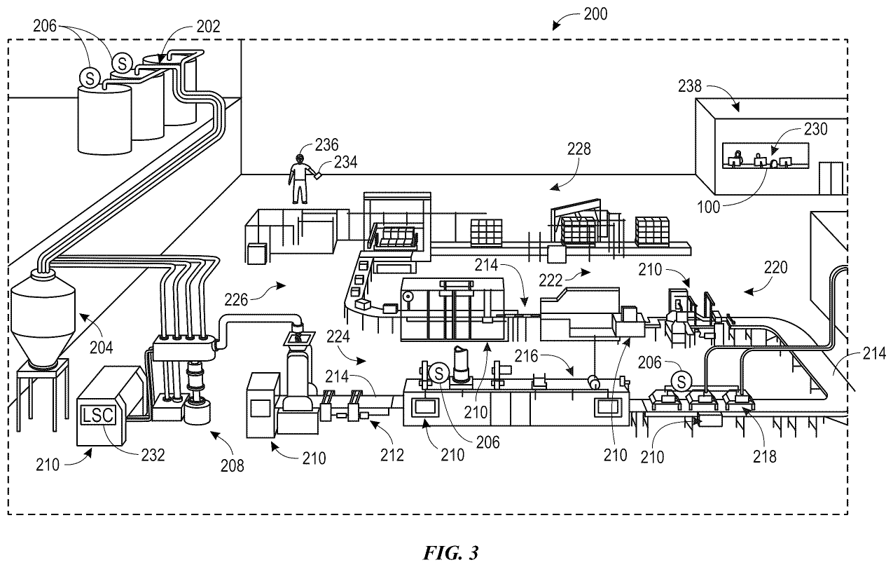

FIG. 3 is a perspective view of an example industrial automation system 200 employed by a food manufacturer. It should be noted that although the example industrial automation system 200 of FIG. 3 is directed at a food manufacturer, the present embodiments described herein may be employed within any suitable industry, such as automotive, cosmetics, chemical manufacturing/processing, mining, hydrocarbon or petrochemical production, manufacturing, and the like. The following brief description of the example industrial automation system 200 employed by the food manufacturer is provided herein to help facilitate a more comprehensive understanding of the OT environment to which the techniques described herein may be applied. As such, the embodiments described herein should not be limited to being applied to the example depicted in FIG. 3.

The example industrial automation system 200 for a food manufacturer may include any number of machines, such as sensors 206 associated with silos 202 and tanks 204. The silos 202 and the tanks 204 may store different types of raw material, such as grains, salt, yeast, sweeteners, flavoring agents, coloring agents, vitamins, minerals, and preservatives. In some embodiments, sensors 206 may be positioned within or around the silos 202, the tanks 204, or other suitable locations within the industrial automation system 200 to measure certain properties, such as temperature, mass, volume, pressure humidity, and the like. For example, the sensor 206 may acquire sensed data that indicates a level of raw material within a respective silo 202, tank 204, or the like.

The raw materials may be provided to a mixer 208, which may mix the raw materials together according to a specified ratio. The mixer 208 and other machines in the industrial automation system 200 may employ certain industrial automation devices 210 to control the operations of the mixer 208 and other machines, like motors, pumps, or the like. The industrial automation devices 210 may include controllers (e.g., industrial automation controller 12), input/output (I/O) modules, motor control centers (e.g., control system 20), motors 14, human-machine interfaces (e.g., user interface 18), operator interfaces, contactors, starters, sensors (e.g., sensor 28, sensors 206), conveyors, drives, relays, protection devices, switchgear, compressors, firewalls, network switches (e.g., Ethernet switches, modular-managed, fixed-managed, service-router, industrial, unmanaged) and the like.

The mixer 208 may provide a mixed compound to a depositor 212, which may deposit a certain amount of the mixed compound onto conveyor 214. The depositor 212 may deposit the mixed compound on the conveyor 214 according to a shape and amount that may be specified to a control system for the depositor 212. The conveyor 214 may be any suitable conveyor system that transports items to various types of machinery across the industrial automation system 200. For example, the conveyor 214 may transport deposited material from the depositor 212 to an oven 216, which may bake the deposited material. The baked material may be transported to a cooling tunnel 218 to cool the baked material, such that the cooled material may be transported to a tray loader 220 via the conveyor 214. The tray loader 220 may include machinery that receives a certain amount of the cooled material for packaging. By way of example, the tray loader 220 may receive 25 ounces of the cooled material, which may correspond to an amount of cereal provided in a cereal box.

A tray wrapper 222 may receive a collected amount of cooled material from the tray loader 220 into a bag, which may be sealed. The tray wrapper 222 may receive the collected amount of cooled material in a bag and seal the bag using appropriate machinery. The conveyor 214 may transport the bagged material to case packer 224, which may package the bagged material into a box. The boxes may be transported to a palletizer 226, which may stack a certain number of boxes on a pallet that may be lifted using a forklift or the like. The stacked boxes may then be transported to a shrink wrapper 228, which may wrap the stacked boxes with shrink-wrap to keep the stacked boxes together while on the pallet. The shrink-wrapped boxes may then be transported to storage or the like via a forklift or other suitable transport vehicle.

To perform the operations of each of the devices in the example industrial automation system 200, the industrial automation devices 210 may be used to provide power to the machines used to perform certain tasks, provide protection to the machines from electrical surges, prevent injuries from occurring with human operators in the industrial automation system 200, monitor the operations of the respective device, communicate data regarding the respective device to a supervisory control system 230, and the like. In some embodiments, each industrial automation device 210 or a group of industrial automation devices 210 may be controlled using a local control system 232. The local control system 232 may receive data regarding the operation of the respective industrial automation device 210, other industrial automation devices 210, user inputs, and other suitable inputs to control the operations of the respective industrial automation devices 210.

An operator device 234 is an example of the computing device 26 that enables an operator 236 to access or interface with other industrial automation devices 210 and/or computing devices. For example, the operator device 234 may include the processor 102, busses 104, memory 106, input structures 108, power source 110, network interface 112, and user interface 114.

Collectively, any or all of the machines (e.g., mixer 208, palletizer 226), the industrial automation devices 210, the computing devices 26, the remote/cloud server 30, the supervisory control system 230, and any other elements of FIG. 3 may constitute the OT environment. These elements may communicate across the OT environment via a network, such as a local area network (LAN). In some embodiments, the network may be managed from a network operations center 238 (NOC). The NOC 238 is a centralized location from which a network administrator may monitor and manage the network. For example, the NOC 238 may include a central computing system which executes a network security system, monitors traffic into and out of the network, maintains databases, and manages security policies. As shown, the NOC 238 is local to the industrial automation system 200, but in other embodiments, the NOC 238 may be located at a remote location.

With the foregoing in mind, the present disclosure seeks to reduce the time and the computing resources expended in handling relatively large volumes of quotation requests, which may be unstructured data in diverse formats (e.g., multi-mode or multimodal) including text, images, table data structures, audio, and the like, in diverse languages including English, Spanish, Dutch, German, Chinese, or any language, and the like. Systems and methods described herein may pre-process a quotation request, leading to a reduced likelihood of errors in the quotation generation process. The system may pre-process the quotation request in response to receiving the quotation request. The pre-processing may include identifying a format of data included in the quotation request and converting the data into a text format. The system may leverage generative AI operations to process the text data to identify information to guide generation of a bill of materials. By using generative AI operations and documents associated with the industrial automation system, the system may identify any missing or incorrect information from the quotation request. The system may store information extracted from the quotation request in a data structure. The system may process the quotation request, which may include unstructured, complex data, to generate a data structure, which may be based on a data structure template applied to different types of quotation requests, with additional information beyond that included in the quotation request. By doing so, the system may reduce duplicated computer operations based on this systematic approach to pre-processing for BOM generation, which may reduce computing resources consumed performing these processing operations. The system, through the generation of the data structure based on the data structure template and based on unstructured data, may apply a systematic approach that reduces errors arising from disorganized or incomplete quotation request data.

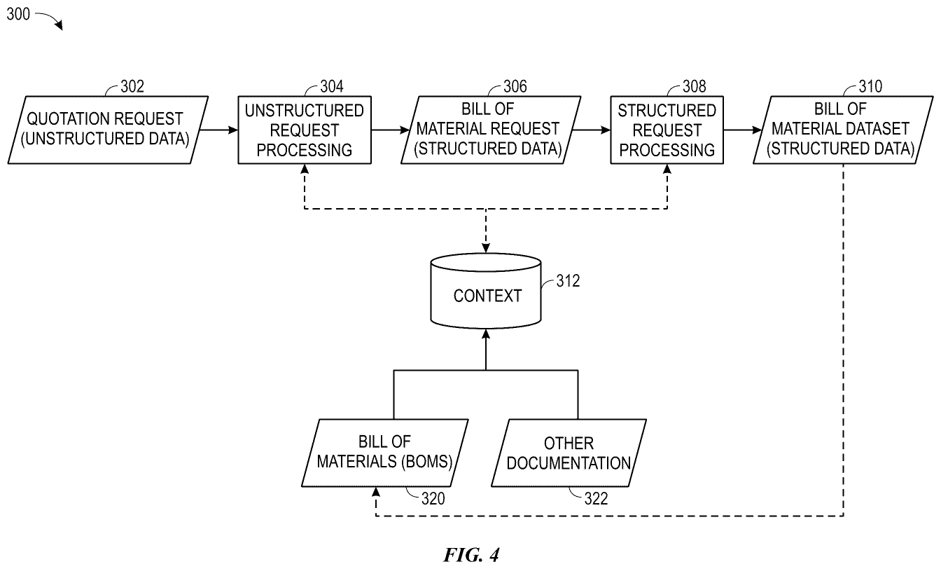

With the foregoing in mind, FIG. 4 illustrates a block diagram of a bill of materials processing system (BOM processing system) 300 that generates a bill of materials dataset (BOM dataset) based on unstructured request processing. The BOM processing system 300 may be described herein as performing operations in a particular order, and it should be understood that some of these operations may be performed in a different suitable order. A computing device 26 may include non-transitory, tangible, computer-readable medium (e.g., memory 106) storing instructions that, when executed by one or more processors (e.g., processors 102), enable the computing device 26 to perform the operations as the BOM processing system 300. It should be noted that any suitable computing device (e.g., operator device 234, computing device 26, computing devices coupled to the remote/cloud server 30, the remote/cloud server 30 itself, or the like), or a combination of computing devices, may provide the BOM processing system 300.

A requesting device may generate a quotation request 302. The quotation request 302 may trigger bill of materials generation operations of the BOM processing system 300. As part of the bill of materials generation operations, the BOM processing system 300 may extract data from the quotation request 302 (e.g., based on processing operations, based on unstructured request processing operations 304) to generate a bill of materials request (BOM request) 306. The BOM processing system 300 may access data in the BOM request 306 (e.g., based on processing operations, based on structured request processing operations 308) to generate a bill of materials dataset (BOM dataset) 310 that includes structured data from the BOM request 306. The BOM processing system 300 may store the generated BOM dataset 310 as feedback data to a context database 312, which may be accessible in a future or at least partially overlapping processing operation as the BOM dataset 320.

Elaborating further on the bill of materials generation operations of the BOM processing system 300, the quotation request 302 may include unstructured data. The BOM request 306 may include structured data, where the structured data may include at least some portion of data extracted from unstructured data of the quotation request 302. The BOM processing system 300 may extract data from the unstructured data based on unstructured request processing operations 304. The BOM processing system 300 may write the extracted data into a quotation data structure generated as a copy of a data structure template, where data stored in fields of the quotation data structure may form the structured data of the BOM request 306. By doing so, the BOM processing system 300 may re-structure the unstructured data according to a data structure template read from memory. Through use of the data structure template, which may be repeatedly copied for different BOM requests 306 at different times and different requestor devices, the BOM processing system 300 may reduce duplicated computer operations by applying a systematic approach to pre-processing of the quotation request 302, which may reduce computing resources consumed performing these processing operations. The BOM processing system 300, through the generation of the data structure based on the data structure template and based on unstructured data, may apply a systematic approach that reduces errors arising from disorganized or incomplete quotation requests 302.

A variety of data may be received with the quotation request 302. Data received as part of the quotation request 302 may have no set format, no set content, and vary from request to request even when from a same requestor device (e.g., even when enterprise identifier is the same between different requests), leading to the generalized description of the data of the quotation request 302 as “unstructured data” or data with a relatively high amount of unpredictable format and content. The quotation request 302 may correspond to an electronic communication, such as an electronic mail (e-mail). The quotation request 302 may include any suitable transmittable data format, such as alphanumerical data (e.g., text data), image data, image data over time (e.g., video data), audio data, data structure or tabular data, or the like.

Based on what type of data is transmitted in the quotation request 302, the BOM processing system 300 may change what type of processing is performed as the unstructured request processing operations 304. The BOM processing system 300 may be agile in its processing such that the processing can handle any format and context of the quotation request 302 regardless of whether the BOM processing system 300 has specifically been trained on or previously handled that combination of data prior.

The unstructured request processing operations 304 may include any suitable processing operations, such as generative AI operations, machine learning operations, natural language processing operations, or the like. The unstructured request processing operations 304 may have been trained using supervised training operations, unsupervised training operations, or other suitable training operations. Through training, weights may be generated that may be applied to algorithms used during the unstructured request processing operations 304 which may tailor the processing to the training. The unstructured request processing operations 304 may use one type of processing for one type of data and may use a second, different type of processing for a second type of data. Indeed, generative AI operations may be used in processing some data and not all data. Benefits to doing so may be that GenAI process may be relatively resource and compute intensive so doing a combination of approaches may result in greater processing efficiency that balances specialized output generation with costs and overall enterprise interests. For example, when the quotation request 302 includes image data, the unstructured request processing operations 304 may involve the BOM processing system 300 generating a function call to communicate with an external or locally executed generative AI application to perform image data processing to extract text data from the image data. When the quotation request 302 includes audio data, the unstructured request processing operations 304 may involve the BOM processing system 300 generating a function call to communicate with an external or locally executed generative AI application to perform audio data processing to extract text data from the audio data. When the quotation request 302 includes data structure data or tabular data, the unstructured request processing operations 304 may involve the BOM processing system 300 generating a function call to communicate with an external or locally executed generative AI application to perform data structure processing to extract text data from the data structure data, which may include reformatting the data structure data to enable headers or row/column titles to enhance the extracted text data, further providing context to the extracted text data.

In some cases, the BOM processing system 300 obtains data from the context database 312 based on the extracted data, such as to obtain information to be included in the BOM request 306 otherwise missing or non-extractible from the quotation request 302. In some cases, the BOM processing system 300 obtains data from the context database 312 based on the extracted data, such as to obtain information to be included in the BOM dataset 310 otherwise missing or non-extractible from the BOM request 306. The unstructured request processing operations 304, the structured request processing operations 308, or both may be based on data stored in a context database 312.

In a first example, the electronic communication received as the quotation request 302 may include a sender identifier and a product identifier and may omit a quantity term. The BOM processing system 300 may obtain data from the context database 312 to identify the omitted quantity term. The BOM processing system 300 may generate the BOM request 306 with data that includes the extracted data of the sender identifier and the product identifier and the query request data of the quantity term.

In a second example, the electronic communication received as the quotation request 302 may include a sender identifier, an enterprise identifier, an image of a nameplate of a machine installed in an industrial automation system and may omit a product identifier and a quantity term. The BOM processing system 300 may obtain data from the context database 312 to confirm the omitted product identifier and to identify the omitted quantity term. The BOM processing system 300 may generate the BOM request 306 with data that includes the extracted data of the sender identifier and the enterprise identifier, the extracted and confirmed product identifier, and the query request data of the quantity term.

In a third example, the electronic communication received as the quotation request 302 may include an enterprise identifier and an image of a nameplate of a machine installed in an industrial automation system, and may omit a product identifier, a quantity term, and a sender identifier. The BOM processing system 300 may obtain data from the context database 312 to confirm the omitted product identifier and to identify the omitted quantity term. For example, the BOM processing system 300 may identify the omitted quantity term by analyzing data stored in the context database 312 for that industrial automation system to identify a quantity of that type of machine installed and extrapolate the quantity as matching the quantity of that type installed. In some cases, the quantity may correspond to a subset of the type of machine installed where data (e.g., the data stored in the context database 312) indicates that the subset is ready for further maintenance operations. The BOM processing system 300 may generate the BOM request 306 with data that includes the extracted data of the enterprise identifier, the extracted and confirmed product identifier, and the data of the quantity term and the sender identifier obtained through querying the context database 312.

In a fourth example, the electronic communication received as the quotation request 302 may include an image of a nameplate of a machine installed in an industrial automation system and may include a data structure indicating product identifiers in association with quantity terms. The electronic communication received as the quotation request 302 may exclude an enterprise identifier and a sender identifier. The BOM processing system 300 may obtain data from the context database 312 to identify the omitted enterprise identifier and the sender identifier, by searching each industrial automation documentation to identify which enterprise identifier corresponds to a system with such a nameplate of the image and which sender identifier corresponds to that enterprise identifier (e.g., as a dedicated enterprise contact to receive BOM datasets 310 on behalf of that enterprise identifier). The BOM processing system 300 may generate the BOM request 306 with data that includes the extracted data of the product identifiers and the quantity terms for each row indicated in the data structure and the query request data of the enterprise identifier and the sender identifier.

In a fifth example, the electronic communication received as the quotation request 302 may include a sender identifier and a data structure with multiple product identifiers and omits quantity terms. The BOM processing system 300 may obtain data from the context database 312 to identify the omitted quantity terms expected to correspond to each product identifier of the multiple product identifiers. For example, the BOM processing system 300 may search the context database 312 to identify subsets of documentation corresponding to the sender identifier, such as an enterprise identifier deemed associated with the sender identifier, and predict quantity terms based on the documentation (e.g., what that enterprise has installed and may be ready for replacement). The BOM processing system 300 may generate the BOM request 306 with data that includes the extracted data of the sender identifier and the product identifiers and the query request data of the quantity terms for each of the product identifiers.

In a sixth example, the electronic communication received as the quotation request 302 may include, in a first language, a sender identifier, a product identifier, and a quantity term. The BOM processing system 300 may extract the sender identifier, the product identifier, and the quantity term from the quotation request 302 and convert into a second language. The BOM processing system 300 may generate the BOM request 306 with data that includes the extracted and converted data of the sender identifier, the product identifier, and the quantity term in the second language.

The context database 312 may be disposed in an IT environment. The context database 312 may be stored in a cloud computing system. For example, the context database 312 may include a blob container. The context database 312 may include data from various databases. The context database 312 may include data extracted from industrial automation system documentation. For example, the context database 312 may include data obtained from input/output (I/O) sheets, piping and instrumentation diagrams (P&IDs), controls layouts, previously generated bill of materials (BOMs) 320, and any other suitable documentation. The context database 312 may include product information integrated from one or more various data sources, like databases, where the product information may include catalog numbers, material types, local material statuses, life cycle statuses, stocking strategy data, minimum order quantity, and the like. The context database 312 may store this information concerning OT environment systems and devices in a layer of the IT environment.

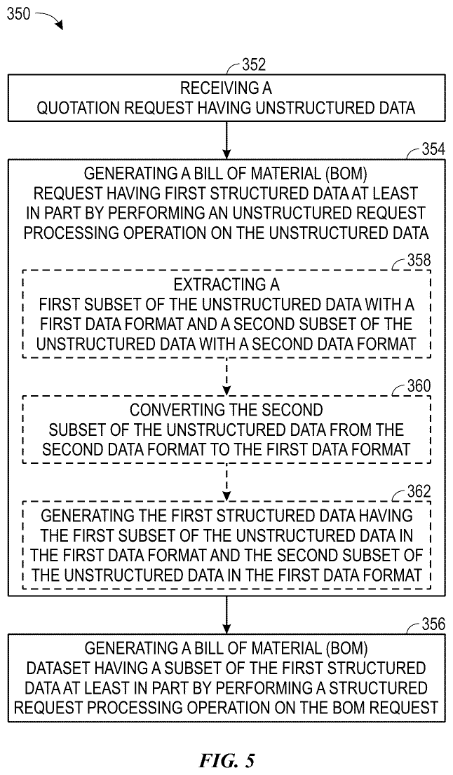

With the foregoing in mind, FIG. 5 is a flow chart of a process for generating a BOM dataset, such as the BOM dataset 310 described relative to FIG. 4. Although the following description of the process 350 is described in a particular order, which represents a particular embodiment, it should be noted that the process 350 may be performed in any suitable order. Moreover, although the following description of process 350 is described as performed the BOM processing system 300, it should be noted that the process 350 may be performed by any suitable computing device, or a combination of computing devices, providing the BOM processing system 300 in association with one or more OT environments. For example, any suitable processing circuitry (e.g., processor 102) may perform operations described herein as performed by the BOM processing system 300 when able to access memory (e.g., memory 106) storing instructions that, when executed by the processing circuitry, cause the processing circuitry to perform operations of the process 350.

At block 352, the BOM processing system 300 may receive a quotation request, like the quotation request 302, which may include unstructured data. The unstructured data may correspond to an open formatting of these communications, such as to permit a near infinite or infinite number of combinations of data included with the quotation request. For example, two client devices may not send a same quotation request even when the quotation request is received in association with a same enterprise identifier, a same industrial automation system, a same machine, or the like. For example, the quotation request may correspond to an e-mail that includes image data, such as a nameplate physically disposed on a machine of the OT environment 10. For example, the quotation request may correspond to an e-mail that includes a data structure that indicates multiple products installed in the OT environment 10 in association with respective requested quantities to be quoted as part of a bill of materials. In some systems, the BOM processing system 300 may receive a quotation request based on receiving, via a first application programming interface (API), an incoming post request. The incoming post request may include, as a payload, the unstructured data of the quotation request or the quotation request itself.

At block 354, the BOM processing system 300 may generate a bill of materials (BOM) request having first structured data at least in part by performing an unstructured request processing operation on the unstructured data. The structured data may include or be a quotation data structure. Generating the BOM request may involve the BOM processing system 300 writing a first subset of the unstructured data of the quotation request 302 in a first data format and a second subset of the unstructured data converted into the first data format into one or more fields of a quotation data structure. The quotation data structure may correspond to a data structure template used for multiple quotation data structures over the course of operation. The BOM processing system 300 may read the data structure template from memory, make a copy of the data structure template as the quotation data structure, preserving the data integrity of the data structure template. The BOM processing system 300 may write data to a field of the quotation data structure as part of generating the structured data of the BOM request 306. In some systems, at block 354, the BOM processing system 300 may convert the first subset of the unstructured data from the first data format in a first language to a second language. The BOM processing system 300 may write the first subset of the unstructured data in the second language to a first field in the quotation data structure. The BOM processing system 300 may convert the second subset of the unstructured data from the first data format in a first language to the second language. The BOM processing system 300 may write the second subset of the unstructured data in the second language to a second field in the quotation data structure. The first field and the second field may be adjacent or non-adjacent relative to each other within the quotation data structure.

At block 356, the BOM processing system 300 may generate a bill of materials (BOM) dataset having a subset of the first structured data at least in part by performing a structured request processing operation on the BOM request. The structured request processing operation may include the BOM processing system 300 receiving, via a bill of materials (BOM) generator, structured data in the quotation data structure. The structured request processing operation may include the BOM processing system 300 extracting an identifier and a quantity, or any suitable combination of fields, from the structured data. The structured request processing operation may include the BOM processing system 300 generating the BOM dataset 310 with the identifier and the quantity. Once generated, the BOM processing system 300 may send, via an API (e.g., the first API from block 352), an outgoing post request with the BOM dataset as a payload.

In some systems, at block 354, the BOM processing system 300 may perform operations of blocks 358-362. The operations of blocks 358-362 may be performed as part of the unstructured request processing operation (e.g., unstructured request processing 304). It is noted that operations of blocks 358-362 are one example of the unstructured request processing operation and other suitable operations may be performed with or in alternative of these operations of blocks 358-362.

At block 358, the BOM processing system 300 may extract a first subset of the unstructured data with a first data format and a second subset of the unstructured data with a second data format. The BOM processing system 300 may extract the first subset of the unstructured data, the second subset of the unstructured data, or both based on an extraction process selected based on classifying the data as a data format. For example, how the BOM processing system 300 extracts a data subset from the quotation request 302 may be based on whether the data subset has a text data format, an image data format, an audio data format, a data structure or tabular format, or the like. A first extraction process (e.g., data parsing relative to image data within email data) to extract image data from the quotation request 302 may differ from a second extraction process (e.g., text data parsing relative to email data) to extract text data from the quotation request 302, which both may differ from a third extraction process (e.g., optical character recognition operation) to extract text data from the image data extracted using the first extraction process from the quotation request 302.

At block 360, the BOM processing system 300 may convert the second subset of the unstructured data from the second data format to the first data format. For example, the second subset of the unstructured data may be image data from which the BOM processing system 300 extracts text data. As another example, the second subset of the unstructured data may include image data that the BOM processing system 300 extracts text data from and then converts the extracted text data into a different language.

At block 362, the BOM processing system 300 may generate the first structured data having the first subset of the unstructured data in the first data format and the second subset of the unstructured data in the first data format. The structured data may correspond to a data structure with fields. In the fields, the structured data may include portions of the unstructured data. For example, the unstructured data may include image data and structured data corresponding to the image data may include extracted text data in a field of the structured data corresponding to information indicated by the extracted text data. Through including subsets of the unstructured data in the fields of the structured data, at least some of the unstructured data may become the structured data.

In some cases, the unstructured data may include first text data and image data. In these cases, the unstructured request processing operation performed relative to block 354 may include the BOM processing system 300 extracting, based on one or more calls with a generative artificial intelligence processing API, second text data from the image data. When performed as part of operations of block 358, the first data format may be text or alphanumerical data format, and the second data format may be image data format. The BOM processing system 300 may convert the first text data from a first language into a second language, such as part of operations of block 360. The BOM processing system 300 may extract second text data from the image data and convert the second text data from a first language into a second language (or may extract the second text data in the second language bypassing a dedicated conversion operation). The BOM processing system 300 may write the converted first text data and the converted second text data to one or more fields of a quotation data structure as the fields of the first structured data, such as part of operations of block 362.

In some systems, the BOM processing system 300 may receive the quotation request at least in part by accessing an electronic communication thread, which may include multiple electronic communications transmitted or received at different times. Each electronic communication of the electronic communication thread may have a different time stamp of transmission or receipt. The BOM processing system 300 may identify the latest received electronic communication of the multiple electronic communications of the thread based on the different time stamps, and which of the time stamps was relatively more proximate to a current time maintained or accessed by the BOM processing system 300. The BOM processing system 300 may handle the latest received electronic communication as the quotation request with the unstructured data. Indeed, the BOM processing system 300 may extract the unstructured data from the latest received electronic communication, where the unstructured data may include multiple data formats to be subjected and processed based on the unstructured request processing operation of block 354.

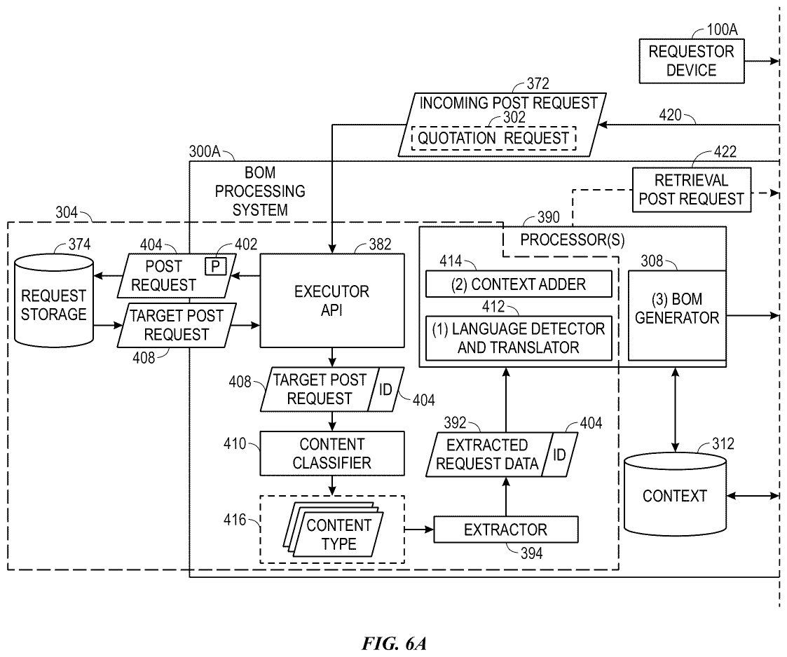

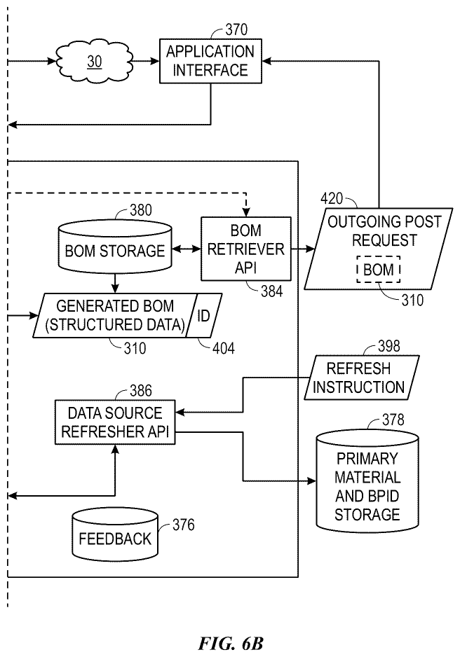

Keeping the foregoing in mind, an example system incorporating the systems and methods described relative to FIGS. 4-5 is illustrated in FIGS. 6A-6B. FIGS. 6A-6B combine to form a block diagram of an example of a BOM processing system 300 of FIG. 4. The BOM processing system 300A may be an example of the BOM processing system 300 of FIG. 4. As such, earlier descriptions may be relied upon herein without specific reference back to FIG. 4. In some cases, the BOM processing system 300A may include additional or alternative components, processing resources, processing circuitry, applications, or the like to perform or enable performance of one or more operations described herein. In some systems, some of the depicted components or described operations are omitted from an actual implementation. Furthermore, example data paths and signal exchanges are illustrated in FIGS. 6A-6B and it should be understood that these are not exclusive illustrations. Indeed, additional or alterative data paths or signal exchanges may occur in an actual implementation.

The BOM processing system 300A may include or access one or more databases. For example, the one or more databases may include a request storage database 374, the industrial automation context database 312, a feedback database 376, a primary material and BPID storage database 378, and a bill of materials storage database (BOM storage) 380. The one or more databases may include one or more memory resources dedicated to the BOM processing system 300A. The one or more databases may be managed and/or provisioned based on a database control system, which may include backup management, backup routing, failover switching, or the like to ensure a suitable reliability of data stored within the one or more databases. The BOM processing system 300A may read to and write from the one or more databases without itself being concerned about backup management or other provisioning operations.

The BOM processing system 300A may operate based on one or more application programming interfaces (APIs). The one or more APIs may include an executor API 382, a BOM retriever API 384, a data source refresh API 386, or the like. APIs may be a communicative coupling or programmatic interface between computers, such as processing circuitry, or between applications or software executed on the computers. A respective API may be a type of a software interface, offering a service or access to a service to other pieces of software or applications. Through shared use of an API, data may be received or transmitted between devices through standardized formatting and protocols. For example, a first processing resource may transmit a request to a second processing resource through a first API, where through use of the first API, the request transmitted may be received by the second processing resource in a format and protocol compliant with operations performed by the second processing resource. Data may be transmitted via an API or received via an API through one or more wired or wireless connections between one or more processing devices, between one or more software applications executed by a processing resource, or the like. An API may receive or transmit data based on hardwired connections between two computers, where an API specification may define a protocol and format to use to enable seamless or relatively lower complexity communications between the computers when compared to use without the API.

The BOM processing system 300A may operate based on one or more processors 390, which may include one or more computers, one or more processing circuitries, one or more processing resources, or the like. The one or more processors 390 may perform one or more generative artificial intelligence operations, one or more machine learning operations, one or more artificial intelligence operations, or the like. In some cases, one or more of the processors 390 may access off-site or externally hosted artificial intelligence-based applications through generating function calls and transmitting the function calls to an API of the off-site or externally hosted artificial intelligence-based applications. The one or more processors 390 may apply machine learning techniques on extracted request data 392 extracted or generated via an extractor 394. For example, the one or more processors 390 may input the extracted request data 392 into a large language model (LLM) with a prompt to generate an industrial automation project based on the contextual data. The LLM may be trained according to a number (e.g., thousands) of lines of programmatic code and a set of industrial automation rules. The lines of programmatic code may be portions of historical BOM datasets (e.g., data associated with or used to generate BOM datasets 310 in the past), entire historic industrial automation projects, portions of theoretical industrial automation projects (e.g., projects that follow industrial automation rules but are not associated with or being used to control a physical industrial automation system), other data included in the context database 312, or a combination thereof. The set of industrial automation rules may include guidelines that define or dictate relationships between industrial automation devices or components. For example, the set of rules may define or dictate connections between devices (e.g., a rule that an input of one device should not be connected to an input of another device), a preference that two devices should not be used together, a preference that two devices should be used together, and the like. The set of rules may also reflect preferences for the BOM dataset 310, such as naming conventions to be followed when generating the BOM dataset 310, devices to avoid being quoted together, quantity or type definitions on a per-enterprise or per-industrial automation system basis, such as an operational cap that no more than two motors with a cost greater than a threshold cost being allowed to be automatically added to a BOM dataset 310, or a limit to what types of products are able to be included in the BOM dataset 310 on a per-enterprise or per-industrial automation system basis, or the like. The LLM and its training data (e.g., lines of programmatic code and rules set) may be stored locally on the one or more processors 390 and/or stored remotely in the remote/cloud server 30. The remote/cloud server 30 may be owned and operated by an entity associated with the one or more processors 390 (e.g., an enterprise managing the BOM processing system 300A). Accordingly, the LLM and its training data may be securely stored, thereby preventing or reducing the likelihood of a data breach by a third party.

An application interface 370 may provide an interface through the BOM processing system 300A may receive a communication from another device, like the requestor device 100A or another suitable client device. The application interface 370 may be an API. The application interface 370 may be a web-based portal interface through which the requestor device 100A may upload the quotation request 302. The requestor device 100A may access the application interface 370. The requestor device 100A may access the application interface 370 through the remote/cloud server 30. Although illustrated as communicating through the remote/cloud server 30 to the application interface 370, it should be understood that the requestor device 100A may be any suitable computing device, such as a device associated with the remote/cloud server 30, associated with an enterprise-side provision of a software-as-a-service provided to enterprises associated with OT environments 10, the computing devices 26, a device disposed between the remote/cloud server 30 and the application interface 370, or the like. Any suitable computing system may access the application interface 370 through a dashboard of an industrial automation software package, such as a package provided as a software-as-a-service remotely accessible at a facility of any of the OT environments 10 via an edge device communicatively coupled to the remote/cloud server 30. Any suitable computing system may access the application interface 370 through a dashboard via a web browser or running as a native application on the client device.

Referring now to operations of the BOM processing system 300A relative to an example quotation request 302, the requestor device 100A may transmit the quotation request 302 to the application interface 370. In response to receiving the quotation request 302, the application interface 370 may generate an incoming post request 372. The BOM processing system 300A may receive a quotation request 302 with unstructured data via the incoming post request 372 or directly without an incoming post request if the system does not use incoming post request.

In some systems, the BOM processing system 300A may receive a quotation request 302 with unstructured data via the incoming post request 372. The BOM processing system 300A may receive the incoming post request 372 from the application interface 370. The incoming post request 372 may encapsulate unstructured data of the quotation request 302. Using the incoming post request 372 may have a technical improvement of enabling some operations to be tied to the issuance of the incoming post request 372, such as instructing the data source refresh API 386 to refresh the context database 312. The data source refresh API 386 may be periodically triggered (e.g., by the refresh instruction 398) to update and refresh the data in the primary material and BPID storage 378 and/or the context database 312. This process may help increase a likelihood or ensure that information used to generate the BOM requests 306 and/or the BOM datasets 310 remains current and accurate. The refresh instruction 398 may be generated by additional processing circuitry based on a refresh parameter that defines how frequently or a periodicity of the refresh instruction 398 generation. For example, the data source refresh API 386 may receive the incoming post request 372 as a refresh instruction 398 and, in response to the refresh instruction 398, may update data stored in a context database 312 to ensure data freshness. The data source refresher API 386 may refresh the context database 312 based on data received from a primary material and BPID storage database 378 in response to the incoming post request 372. This may provide a technical improvement of the BOM dataset 310 being generated based on up-to-date data or based on data that satisfies a freshness condition.

The executor API 382 may receive the incoming post request 372 and/or the quotation request 302 from the application interface 370. The executor API 382 may write the incoming post request 372 as a post request 400 to request storage database 374. In some systems, the executor API 382 may save the quotation request 302 into a blob storage for processing, where the request storage 374 may be the blob storage. The executor API 382 may initiate the processing of newly uploaded quotation request 302 files that have not yet been processed and files that encountered errors during previous processing attempts on time intervals, such as every 10 minutes, every 15 minutes, every 1 hour, or the like. The executor API 382 may assign priority data 402 to the post request 400. The executor API 382 may assign the priority data 402 based on time stamps of the different requests (e.g., to save a most recent in time communication), a longest request, like with the most text, or the like. In some systems the executor API 382 associates priority data 402 with the post request 400 based on the requesting device's priority, a priority of the requestor device 100A, or an indication of a priority included in the incoming post request 372, which may indicate whether the quotation request 302 has a relatively higher urgency, or the like.

The executor API 382 may associate an identifier 404 with the incoming post request 372, where the identifier is stored in a mapping database (not illustrated) in association with an indication of a mapping between that incoming post request 372 and a requesting device (e.g., device connected to the requestor device 100A, the requestor device 100A). The identifier 404 may correspond to data that indicates an internet protocol address (IP address) of the requesting device, an enterprise identifier of the requesting device, a user identifier, or the like. The identifier 404 may enable the application interface 370 to return any generated BOM datasets 310, error messages, or other communications to the requestor device 100A. In some systems, the executor API 382 may store the quotation request 302 (e.g., with the post request 400, extracted from and without the post request 400, with the priority data 402, without the priority data 402) in the request storage database 374. Doing so may permit the BOM processing system 300A to repeat processing in case an error or processing drops by preserving the original quotation request 302 for a threshold amount of time. In cases where priorities 404 are used, the BOM processing system 300A may process some requests (e.g., quotation requests 302, post requests 400 including a quotation request 302) with higher priorities before other requests with lower priorities.

In some systems, the requestor device 100A does not generate the original quotation request 302 and selects between candidate quotation requests 302. For example, the requestor device 100A may identify, via a thread detector, a latest communication in an electronic communication thread. The electronic communication thread may include multiple electronic communications transmitted or received via the requestor device 100A at various times. Each electronic communication of the electronic communication thread may have a different time stamp of transmission or receipt. The requestor device 100A may identify a latest received electronic communication of the multiple electronic communications of the thread based on the different time stamps, and which of the time stamps was relatively more proximate to a current time maintained or accessed by the requestor device 100A. The requestor device 100A may handle the latest received electronic communication as the quotation request with the unstructured data. The requestor device 100A may extract the unstructured data from the latest received electronic communication, where the unstructured data may include multiple data formats to be subjected and processed based on the unstructured request processing operations 304.

The request storage database 374 may include a queue to track which post requests 400 were received first, which may be processed first. Some users profiles (e.g., logged in to the requesting device, original generator of the quotation request 302) may have a priority assignment, and thus requests received from a requesting device having an account logged in with the higher priority, may be associated in memory with priority data 402 with the post request 400 such that BOM processing system 300A reads the higher priority requests first. A post request 400 read from the request storage database 374 for processing may be a target post request 408. The executor API 382 may receive the target post request 408 and transmit for further processing with the identifier 404.

The BOM processing system 300A may perform unstructured request processing operations 304 on the target post request 408 (e.g., including the quotation request 302) based on a content classifier 410, an extractor 394, and a subset of the one or more processors 390 (e.g., language detector and translator 412, context adder 414). The content classifier 410 may identify different content types 416 within the quotation request 302 of the target post request 408. For example, the BOM processing system 300A may classify, using the content classifier 410, a first subset of the unstructured data as a first data format and a second subset of the unstructured data as a second data format. Together, the content classifier 410 and the extractor 394 may identify and extract content from the unstructured data transmitted via the target post request 408, the extracted content types corresponding to one or more of: text data, tabular data structure, audio data, and image data. The extracted data may correspond to text data. For example, image data of the unstructured data may be classified as image data by the content classifier 410 then extracted as text data by the extractor 394 using an image data-specific operation, which may be based on generative AI processing operation. The extractor 394 may perform or coordinate performance of a generative AI processing operation, a natural language processing operation, a neural network processing operation, or the like. The training of any of those operations may be updated overtime responsive to validation received from the requesting devices, intermediate devices, or the like.

The BOM processing system 300A processes the extracted request data 392 based on the one or more processors 390 to detect a language and translate between languages and/or to identify omitted data in the quotation data structure and add data to cure the omissions. In doing so, the one or more processes, may read a data structure template from memory to interpret fields of a quotation data structure (e.g., if the extractor 394 writes the extracted request data 392 to the quotation data structure directly) and/or to generate a quotation data structure based on the extracted request data 392 (e.g., if the extractor 394 does not write the extracted request data 392 to the quotation data structure directly).

For example, the one or more processors 390 may determine, via the context adder 414, whether any catalog numbers or data is missing, like whether a field includes null data. If the data is missing, the one or more processors 390 may perform a logical operation (e.g., OR operation, AND operation, NOR operation, NAND operation, XOR operation) to compare multiple queries of subsets of the translated content. If no data is missing, then the one or more processors 390 may continue to determine if all desired data fields are filled with data. If yes, the one or more processors 390 may not send the data for additional validation and may proceed to generate the BOM dataset 310. If no, the one or more processors 390 may send the data for additional validation to another system and may wait generate the BOM dataset 310 until the validated data (e.g., completed BOM request 306. The one or more processors 390 may write a generated BOM dataset 310 having structured data to BOM storage 380.

For example, the one or more processors may detect and translate, via the language detector and translator 412, which may correspond to a processing resource of the BOM processing system 300A or accessible to the BOM processing system 300A, such as through a generative AI API. The BOM processing system 300A may convert, through detection and translation using the language detector and translator 412, at least a portion of the unstructured data from a first language to a second language. The detection and translation may be between languages, such as German, English, Chinese, Japanese, Spanish, Arabic, or any suitable language. The detection and translation may be between computer protocols or programming languages. For example, the quotation request 302 may be received through a text format used in a first programming language based in English and converted into a second text format used in a second programming language also based in English. The detection and translation may be based on generative AI operations performed by the one or more processors 390 or accessible to be performed responsive to the BOM processing system 300A commands, such as through the generative AI API.

The BOM processing system 300A may write, using the subset of the one or more processors 390, the first subset of the unstructured data in the second language and the second subset of the unstructured data in the second language to a quotation data structure having the data structure template. Unstructured data may be written to a quotation data structure. The quotation data structure may be a copy of a data structure template shared by multiple quotation requests, enabling standardization between quotation requests from multiple enterprises, multiple computing devices, multiple originating countries or states, and the like. Each of the one or more processors 390 may be programmed to write data into the quotation data structure. This may enable translated data to be written to the quotation data structure after translation by the language detector and translator 412 at an at least partially overlapping time relative to writing data extracted from the context adder 414 read from the context database 312. Allowing parallel writing operations to the quotation data structure may enable multiple processing operations to be pipelined, which may take less time than individually processing each data sequentially.

The BOM processing system 300A may supplement data for missing (e.g., null data) fields based on context data derived from other communications in the electronic communication thread, supplementary data from a material primary database, such as the context database 312. To do so, the BOM processing system 300 may use the context adder 414 to identify missing data in the quotation data structure and to search the context database 312 for related descriptions or missing data, to search metadata of the electronic communication thread, or another electronic communication thread.

The BOM processing system 300A may generate the BOM dataset 310 based on the performance of a structured request processing operation 308 based on the quotation data structure. The BOM processing system 300A may generate the BOM dataset 310 to include structured data of the quotation data structure, which includes the data identified as the missing quotation data.

The BOM processing system 300A may generate, via a BOM retriever API 384 reading the generated BOM from the BOM storage 380, an outgoing post request 420 including an indication of the generated BOM dataset 310. The BOM retriever API 384 may be used to fetch the generated BOM dataset 310 from the BOM storage 380 for an uploaded file (e.g., the quotation request 302). The BOM processing system 300A may send, via the BOM retriever API 384, the outgoing post request 420 to the requestor device 100A based on the identifier 404. A retrieval post request 422 may cause the BOM dataset 310 to be pushed to the BOM storage 380. The retrieval post request 422 may correspond to a POST request to prepare the generated BOM dataset 310 for email communication back to the requesting device based on the identifier 404 and an email interface, such as triggering any further post processing and/or additional validation operations. The BOM retriever API 384 may read a mapping from a mapping database (not illustrated), where the mapping may map the identifier 404 and the generated BOM dataset 310 to be returned to the requestor device 100A by way of the outgoing post request 420.

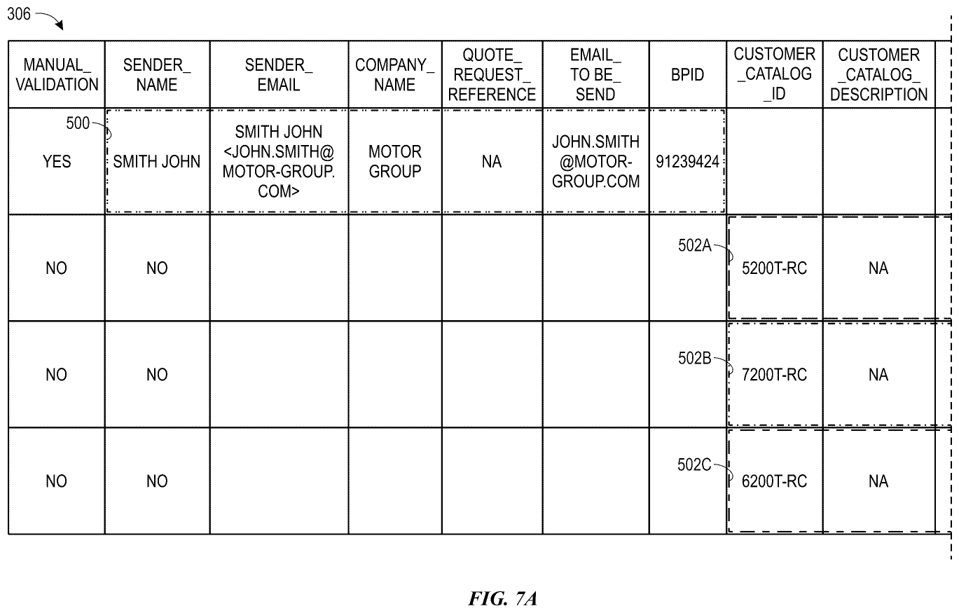

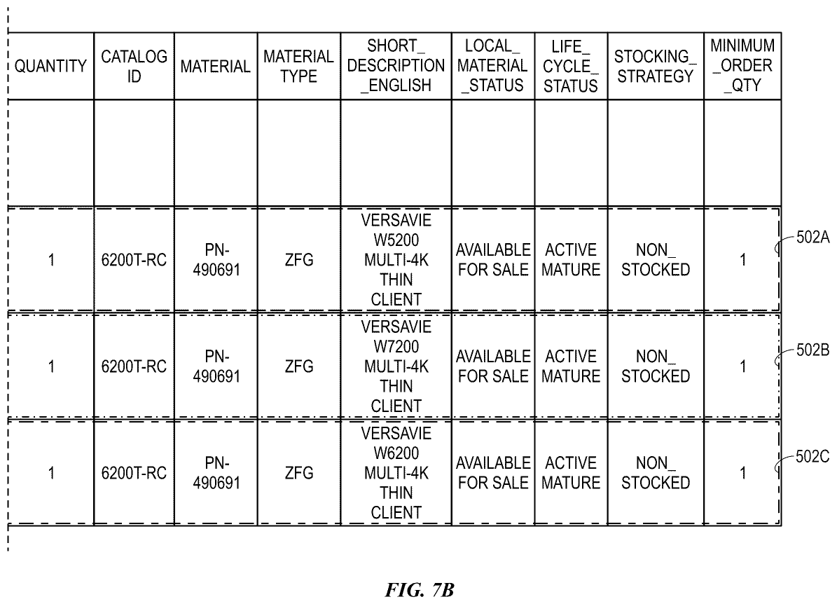

FIGS. 7A-7B together are a diagrammatic representation of an example of a bill of materials request (BOM request) 306 that includes structured data generated based on a quotation request 302. Several types of row and column data is illustrated herein but it should be understood that any suitable row and column data may be used in an actual implementation.

The BOM request 306 may include a quotation data structure with multiple columns and multiple rows. A number of rows may equal at least a first row 500 and a second, product rows 502. The first row 500 may correspond to requestor information. Product rows 502 may correspond to product requested information, which may include at least a first product row 502A corresponding to a single product being requested. A number of the product rows 502 may correspond to a total number of individual catalog identified products being quoted in the BOM dataset 310. The number of the product rows 502 may be greater than a number of products indicated in the quotation request 302 in response to the BOM processing system 300A determining that the quotation request 302 misrepresented the requested product, an error was made, an omission was made, or the like, and responsive to this determination, the BOM processing system 300A may adjust a number of product rows 502 in the quotation data structure to include additional product rows 502 accounting and compensating for the omission. The unstructured data of the quotation request may include at least data written to fields of “email_to_be_send” and “BPID,” which may stand for business process identification number. The BPID may be an authorization number as a unique identifier dedicated to each enterprise customer. The email_to_be_send data may be obtained by the BOM processing system 300C searching the quotation request 302 for a latest email address not associated with an enterprise managing the BOM processing system 300C (e.g., the latest email address from the client or enterprise initiating the quotation request 302). In this example, the quotation request 302 included or was determined to include a request for information of three products, where data corresponding to the respective products in stored in different product rows 502 (product row 502A, product row 502B, product row 502C). By including this structure, where the first row of requestor information includes null data in the portion of the first row adjacent to and logically above the second row(s) of product rows 502, the BOM processing system 300C may more readily query and process the data in the BOM request 306, which may improve efficiency through reducing power, time, or computing resources consumed over the quantity of quotation requests 302 that may be processed (e.g., greater than 10,000 annually, between 15,000 and 25,000 each year).

Columns of the BOM request 306 corresponding to data of the first row 500 may include sender identifier column (“Sender_Name”) and sender email data column (“Sender_Email”). Columns of the BOM request 306 may include an enterprise identifier column (“Company_Name”), quote request reference (“Quote_Request_Reference”), return address data (“Email_Tobe_Send”), BPID identifier column (“BPID”), and so on.

Columns of the BOM request 306 corresponding to data of the product row 502 may include customer product catalog identifier column (“Customer_Catalog_ID”), customer catalog description column (“Customer_Catalog_Description”), quantity data column (“Quantity”), catalog ID of the product manufacturer or BOM dataset 310 generator (“Catalog_ID”), or the like. Columns of the BOM request 306 corresponding to data of the product row 502 may include additional information to provide further context regarding materials, supply status, repair availability, distribution status, or the like. For example, a material column may indicate a material of the product of the Catalog_ID (“Material”), a material type column may provide additional context relative to the Material column data (“Material_Type”), a short description data column (“Short_Description_English”) may set a language of translation to be applied by the language detector and translator 412, a local material status data column (“Local_Material_status”) may indicate whether the product indicated by that product row 502 is still available for sale or not, a life cycle status column (“Life_Cycle_Status”) may indicate whether the product indicated by that product row 502 is still maintained or supported technological the product manufacturer or BOM dataset 310 generator, a stocking strategy column (“Stocking_Strategy”) may indicate whether the product indicated by that product row 502 is kept in stock or not, and a minimum order quantity (“Minimum_Order_Qty”) column may indicate a lowest permitted quantity of the product indicated by that product row 502 that is permitted to be purchased by the product manufacturer or BOM dataset 310 generator, or the like. A similar column may be included to indicate a maximum order quantity, which may indicate an order threshold (e.g., a threshold indicating a maximum quantity that may be made on the order) or a greatest permitted quantity of the product indicated by that product row 502 that is permitted to be purchased by the product manufacturer or BOM dataset 310 generator.

In this example, the product rows 502 may correspond to one or more nested rows. A number of rows of the one or more nested rows may be based on the product identifiers and quantity data included in, extractable from, or determinable from the quotation request 302. Each of the one or more nested rows may include data generated based on the unstructured request processing operations 304 relative to an enterprise identifier and a product identifier (PID). Each row of the one or more nested row may include column data across the respective columns of the one or more columns, where the column data is based on the quantity data.

In some systems, the BOM processing system 300 may be disposed external to an OT environment 10, where a computing device, like the computing device 26, associated with the OT environment 10 may detect a machine is to be replaced, or predict an upcoming maintenance event and determine the machine is about to be replaced, and thus may generate a quotation request 302 to request a bill of materials be generated to enable the machine replacement to occur. The computing device may send the quotation request 302 to the BOM processing system 300. At receipt, the BOM processing system 300 may generate the BOM request 306 based on unstructured request processing operation 304 performed on the quotation request 302 to extract data from unstructured data of the quotation request 302. The BOM processing system 300 may generate the BOM dataset 310 based on structured request processing 308 performed on BOM request 306 to extract data from the structured data of the BOM request 306 for inclusion in the BOM dataset 310.

In some systems, when presented in a graphical user interface (GUI) or human machine interface (HMI) via the computing device, the BOM dataset 310 may present a bill of materials with quote information requested by the computing device. Formatting rules or preferences to be followed by the BOM processing system 300 when generating BOM datasets 310 may be stored as part of the other documentation 322 in the context database 312 or locally in memory accessible during the structured request processing operations 308. For example, the quotation request 302 may include a first enterprise identifier, where a first rule may be stored may be stored in association with a first enterprise identifier in the other documentation 322. The BOM processing system 300 may extract the first enterprise identifier from the quotation request 302 and may search the other documentation 322 for any rules (e.g., the first rule) stored in association with the first enterprise identifier. The searching may return the first rule. The BOM processing system 300 may generate the BOM dataset 310 to comply, at presentation via a GUI, with the first rule. In some cases, the first rule may define what types of products be quoted in the BOM dataset 310, like brands, sizes, material type, or the like. In some cases, the first rule may define what types of products be quoted in the BOM dataset 310 relative to a stocking strategy, for example when the first enterprise has defined that BOM datasets 310 be generated to reflect in stock products. In some cases, the first rule may define a relative placement of structured data within the presentation of image content via the GUI, for example that an enterprise identifier be presented at a top-center of the GUI and product and quantity data be presented middle-center.

In some systems, the requestor device 100A may receive, as edit data, inputs to edit the BOM dataset 310 in response to sending the BOM dataset 310 for presentation via a GUI. For example, the requestor device 100A may receive edit data indicating instructions to add additional components or connections to the BOM dataset 310, rename components or aspects of the BOM dataset 310, add tags to the BOM dataset 310, modify a rule used relative to the BOM dataset 310, or the like. The requestor device 100A may send the edit data to the BOM processing system 300. When the BOM processing system 300 receives the edit data, the BOM processing system 300 may process the edit data to extract and/or generate contextual data, apply generative AI or machine learning techniques on the contextual data, and output a modified copy of the existing BOM dataset 310, which may be returned to the requestor device 100A for presentation via the GUI or further processing. The modified copy may emphasize any changes to the BOM dataset 310 (e.g., new devices may be bolded and/or have an associated indicator, removed features may be displayed in a grayed out or semi-transparent matter, and the like). Additionally, or alternatively, the BOM processing system 300 may generate a text summary describing edits, modifications, or suggestions associated with the autogenerated modified BOM dataset 310, along with rational associated with some or all the changes. For example, the summary may indicate that a device was removed from the BOM dataset 310 for being incompatible with another device, improperly connected to another device, and the like.

For example, referring back to FIG. 5, the operations of process 350 may include receiving an edit through edit data generated relative to the bill of materials; classifying the edit relative to a type of error of thread detection error, a content classifier error, a content extractor error, a language detector error, a language translator error, a context error, a bill of materials generator error, a user interface generator error, or any combination thereof; and writing, to the feedback database 376, the edit with the type of error, where the feedback database may be referenced in retraining one or more AI-based processors. In some systems, as another example, the operations of process 350 may include receiving edit data indicative of an edit made to the BOM dataset 310, generating a second bill of materials based on modifying the BOM dataset 310 to incorporate the edit data.

Any retraining that occurs relative to one or more models, such as one used in a generative AI operation associated with the unstructured request processing operations 304, of a first enterprise identifier may be isolated from models of a second enterprise identifier as to not cross-contaminate training without opt-in indications associated with the first enterprise identifier and the second enterprise identifier. For example, retraining one or more generative artificial intelligence-based processing operations that perform at least some of the unstructured request processing operations 304 based on feedback data received from the requestor device 100A (e.g., communicatively coupled to a client device) after sending the BOM dataset 310, where the feedback data indicates the enterprise identifier. As another example, the BOM processing system 300A may retrain the one or more generative artificial intelligence-based processing operations based on adjusting one or more operations, weights, data sources, or any combination thereof of based on the feedback data. The BOM processing system 300A may program processing resources dedicated for at least some period of time to an enterprise identified by the enterprise identifier based on the one or more retrained generative artificial intelligence-based processing operations, where, once programmed, the processing resources apply the one or more retrained generative artificial intelligence-based processing operations to additional unstructured data including the enterprise identifier.

In some systems, referring back to FIG. 5, the BOM processing system 300 may, at block 356, generate the BOM dataset 310. The BOM dataset 310 may be considered second structured data that includes at least a subset of first structured data (e.g., structured data of the BOM request 306). The BOM dataset 310 may be generated based on the BOM request, like the BOM request 306, at least in part by comparing the BOM request 306 to a data content threshold. Any suitable threshold may be used, such as 50%, 60%, 70%, or a majority of fields include data in the BOM request 306. In some systems, a condition may be satisfied, such as the BOM processing system 300 confirming that one or more identified fields include data in each of the respective fields of the one or more identified fields, like an enterprise identifier may be an identified field, where when the enterprise identifier field is empty (e.g., null data) the BOM processing system 300 delays generating the BOM dataset 310 and performs alternative operations. When the BOM processing system 300 does not determine that the quotation data structure of the BOM request 306 includes a threshold amount of written data or otherwise satisfies a condition, the BOM processing system 300 may identify missing structured data from the quotation data structure based on searching. The searching may be performed relative to an enterprise identifier associated with the quotation data to search a subset of the entire database relevant to the enterprise identifier. When the missing structured data is found, the BOM processing system 300 may generate the bill of materials based on the quotation data structure.

In some systems, the BOM processing system 300 may determine an amount of written data in the quotation data structure, such as a percentage of fields of the quotation data structure that include data. When the amount of written data is less than a threshold amount of written data (e.g., 50% empty fields, 40% empty fields, 30% empty fields, a percentage of empty fields), the BOM processing system 300 may send the quotation data structure to an additional processing system for additional processing operations. The BOM processing system 300 may receive the quotation data structure including greater than the amount of written data from the additional processing system in satisfaction of the threshold amount of written data (e.g., greater than the threshold amount of written data). The BOM processing system 300 may generate the bill of materials based on the quotation data structure after the second time.

In some systems, referring back to FIGS. 6A-6B, although generating the BOM dataset 310 may be based on generative AI operations, the BOM processing system 300A may be strategic in when those operations are called, such as when the BOM processing system 300A determines to apply a relatively more rigorous processing of the quotation request 302. For example, the BOM processing system 300A may perform unstructured request processing operations 304 at least in part by performing at least one function call to a generative artificial intelligence processing API and receiving result data from the generative AI API, which may be further supplemented with additional machine learning or processing operations. The BOM processing system 300A may perform structured request processing operations 308 at least in part by performing a local machine learning operation relative to structured data in the quotation data structure without performing any function calls to the generative artificial intelligence processing API. By reducing a number of function calls to the generative artificial intelligence processing API, the BOM processing system 300A may reduce an overall consumption of tokens, which may reduce overall execution costs and power consumed generating the BOM datasets 310.

The disclosed techniques are directed towards generating structured datasets based on unstructured data of requests for the structured datasets. A computing device of the industrial automation system may generate a quotation request with unstructured data to request a bill of materials be generated relative to the unstructured data (e.g., to generate a pricing quote relative to the unstructured data). A processing system may receive the quotation request, extract data from the unstructured data, write the data to various fields within a quotation data structure copied from a data structure template, and generate a bill of materials dataset based on the quotation data structure. The bill of materials dataset generation operations may be systematic and may help to preserve throughput of the generation operations by using the fields and formatting captured in the data structure template. By leveraging generative AI and documents the processing system may have access to in association with the industrial automation system (e.g., indications of machines installed in the industrial automation system and associated documentation), the presently disclosed techniques may reduce computing costs associated with processing quotation requests, such as from reducing computing resources consumed in identifying missing data in the unstructured data, from duplicated language conversions or extraction operations, among other benefits described herein. Moreover, by using a combination of generative AI operations and a second type of machine learning operations (e.g., large language model, natural language processing), computing resources may be more efficiently tailored to task type. For example, a BOM processing system may consume fewer resources or lower amounts of power where one or more generative AI operations are used for classification, extraction, and/or translation operations, and where the second type of machine learning operations may be used for BOM dataset generation relative to systems that use generative AI operations for each processing task. It is noted that these described systems and methods may be applied or use any suitable file type, language, or the like. For example, systems and methods described herein support .msg. .eml, .pdf, .jpg, .jpeg, .png, .xlsx, .xls, and the like file types.

Systems and methods described herein may assist computing devices associated with a department of an original equipment manufacturer with operating in response to or with responding to inquiries for finished products from end customer computing devices, such as a computing device associated with a distributor of the finished products. Inquiries may be generated by computing devices associated with a different department of the original equipment manufacturer, which may trigger intra-entity distribution of finished products between departments based on respective inquiries.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible, or purely theoretical. Further, if any claims appended to the end of this specification contain one or more elements designated as “means for (perform)ing (a function) . . . ” or “step for (perform)ing (a function) . . . ,” it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A system comprising:
processing circuitry; and
a memory accessible by the processing circuitry, the memory storing instructions that, when executed by the processing circuitry, cause the processing circuitry to perform operations comprising:
receiving a quotation request comprising unstructured data; and
generating a bill of materials (BOM) request comprising first structured data at least in part by performing an unstructured request processing operation on the unstructured data comprising:
extracting a first subset of the unstructured data with a first data format and a second subset of the unstructured data with a second data format;
converting the second subset of the unstructured data from the second data format to the first data format; and
generating the first structured data comprising the first subset of the unstructured data in the first data format and the second subset of the unstructured data in the first data format.

2. The system of claim 1, wherein the unstructured data comprises first text data and image data, and wherein the unstructured request processing operation comprises:
extracting, based on one or more calls with a generative artificial intelligence processing API, second text data from the image data;
converting the first text data from a first language into a second language;
converting the second text data from the first language into the second language; and
writing the converted first text data and the converted second text data to one or more fields of a quotation data structure as the fields of the first structured data.

3. The system of claim 1, wherein the operations comprise generating a bill of materials (BOM) dataset comprising a subset of the first structured data at least in part by performing a structured request processing operation on the BOM request.

4. The system of claim 3, wherein the memory stores a feedback database, wherein the operations comprise retraining one or more generative artificial intelligence-based processing operations that perform the unstructured request processing operation based on feedback data received from the client device after sending the BOM dataset, and wherein the feedback data comprises the enterprise identifier.

5. The system of claim 4, wherein the retraining the one or more generative artificial intelligence-based processing operations comprises:
retraining the one or more generative artificial intelligence-based processing operations based on adjusting one or more operations, weights, data sources, or any combination thereof of based on the feedback data; and
programming processing resources dedicated for at least some period of time to an enterprise identified by the enterprise identifier based on the one or more retrained generative artificial intelligence-based processing operations, wherein, once programmed, the processing resources apply the one or more retrained generative artificial intelligence-based processing operations to additional unstructured data comprising the enterprise identifier.

6. The system of claim 1, wherein the processor is configured to utilize a data source refresher API to refresh a context database from a primary material database in response to the incoming post request.

7. A non-transitory, tangible, computer-readable medium comprising instructions that, when executed by processing circuitry, causes the processing circuitry to perform operations comprising:
receiving a quotation request comprising unstructured data; and
generating a bill of materials (BOM) request comprising a quotation data structure at least in part by:
extracting a first subset of the unstructured data with a first data format; and
writing the first subset of the unstructured data in the first data format into one or more fields of the quotation data structure.

8. The computer-readable medium of claim 7, wherein receiving the quotation request comprises:
accessing an electronic communication thread comprising a plurality of electronic communications having different time stamps;
identifying a latest received electronic communication of the plurality of electronic communications based on the time stamps; and
extracting the unstructured data from the latest received electronic communication, wherein the unstructured data comprises a plurality of data formats.

9. The computer-readable medium of claim 7, wherein generating the BOM request comprises converting the first subset of the unstructured data from the first data format in a first language to a second language.

10. The computer-readable medium of claim 7, wherein the operations comprise generating a bill of materials (BOM) dataset based on the BOM request at least in part by:
determining that the quotation data structure comprises a threshold amount of written data; and
generating the BOM dataset based on the quotation data structure comprising the threshold amount of written data.

11. The computer-readable medium of claim 7, wherein the operations comprise generating a bill of materials (BOM) dataset based on the BOM request at least in part by:
determining that the quotation data structure does not satisfy a condition;
identifying missing structured data from the quotation data structure based on searching a context database, wherein the searching is performed relative to an enterprise identifier associated with the quotation data to search a subset of the entire database relevant to the enterprise identifier; and
when the missing structured data is found, generating the BOM dataset based on the quotation data structure.

12. The computer-readable medium of claim 11, wherein the operations comprise:
receiving an edit to the BOM dataset;
classifying the edit relative to a type of error of thread detection error, a content classifier error, a content extractor error, a language detector error, a language translator error, a context error, a bill of materials generator error, a user interface generator error, or any combination thereof; and
writing, to a feedback database, the edit with the type of error, wherein the feedback database may be referenced in retraining one or more AI-based processors.

13. The computer-readable medium of claim 7, wherein the operations comprise generating a bill of materials (BOM) dataset based on the BOM request at least in part by:
determining an amount of written data in the quotation data structure;
when the amount of written data is less than a threshold amount of written data, sending the quotation data structure to an additional processing system for additional processing operations;
receiving the quotation data structure comprising greater than the threshold amount of written data from the additional processing system; and
generating the BOM dataset based on the quotation data structure after the second time.

14. The computer-readable medium of claim 13, wherein the operations comprise:
receiving an edit to the BOM dataset; and
generating a second BOM dataset based on modifying the BOM dataset to incorporate the edit.

15. The computer-readable medium of claim 7, wherein the first data format comprises a text data format, and wherein the second data format comprises image data, data structure data, or both.

16. The computer-readable medium of claim 7, wherein the operations comprise generating a bill of materials (BOM) dataset based on the BOM request at least in part by:
receiving, via a bill of materials (BOM) generator, structured data in the quotation data structure;
extracting an identifier and a quantity from the structured data; and
generating the BOM dataset comprising the identifier and the quantity.

17. A system comprising:
processing circuitry; and
a memory accessible by the processing circuitry, the memory storing instructions that, when executed by the processing circuitry, cause the processing circuitry to perform operations comprising:
receiving, via a first application programming interface (API), an incoming post request comprising unstructured data;
generating a bill of materials (BOM) request comprising a quotation data structure at least in part by performing unstructured request processing on the unstructured data;
generating a bill of materials (BOM) dataset based on the quotation data structure; and
sending, via the first API, an outgoing post request comprising the BOM dataset.

18. The system of claim 17, wherein performing the unstructured request processing comprises:
classifying a first subset of the quotation data as a first data format and a second subset of the quotation data as a second data format;
extracting data of the first data format from the second subset of the quotation data using a method selected based on the second subset of the quotation data being classified as the second data format;
reading a data structure template from memory; and
writing the first subset of the quotation data in the second language and the second subset of the quotation data in the second language to a quotation data structure having the data structure template.

19. The system of claim 17, wherein:
performing the unstructured request processing on the unstructured data comprises performing at least one function call to a generative artificial intelligence processing API; and
generating the BOM dataset comprises performing local machine learning operations relative to structured data in the quotation data structure without performing any function calls to the generative artificial intelligence processing API.

20. The system of claim 17, wherein the processing circuitry is configured to:
communicate with a cloud server via an application interface accessible through the first API, wherein the cloud server configured to communicate with a client device that transmitted a quotation request comprising the unstructured data, and wherein the unstructured data comprises:
an enterprise identifier, wherein an enterprise identified by the enterprise identifier corresponds to an industrial automation system associated with the client device;
a product identifier (PID), wherein a product identified by the product identifier is installed in the industrial automation system; and
quantity data; and
wherein the BOM dataset comprises:
a plurality of fields comprising:
a first row comprising:
the enterprise identifier; and
the PID; and
one or more nested rows, wherein in a number of rows of the one or more nested rows is based on the PID and the quantity data of the unstructured data, wherein each of the one or more nested rows comprise data generated based on the unstructured request processing of the enterprise identifier and the PID, wherein each row of the one or more nested row comprises column data across the respective columns of the one or more columns, and wherein the column data is based on the quantity data.
